(19) United States
(12) Patent Application Publication
(10) Pub. No.: US 2019/0327695 A1
(43) Pub. Date: Oct. 24, 2019

(54) POWER CONTROL METHOD AND COMMUNICATIONS DEVICE

(71) Applicant: Huawei Technologies Co., Ltd., Shenzhen (CN)

(72) Inventors: Haibao REN, Shanghai (CN); Zheng WANG, Shenzhen (CN); Ting WANG, Shanghai (CN); Yuanjie LI, Shanghai (CN)

(21) Appl. No.: 16/460,638

(22) Filed: Jul. 2, 2019

Related U.S. Application Data
(63) Continuation of application No. PCT/CN2017/118379, filed on Dec. 25, 2017.

(30) Foreign Application Priority Data
Jan. 3, 2017 (CN) 201710002391.4

(51) Int. Cl. H04W 52/54; H04W 72/04; H04W 8/24; H04W 52/36; H04W 52/34; H04W 76/11

(52) U.S. Cl. CPC H04W 52/54; H04W 72/0473; H04W 72/046; H04W 76/11; H04W 52/367; H04W 52/34; H04W 8/24

(57) ABSTRACT

Embodiments of this application disclose a power control method, including: sending, by a first device, a first message to a second device, where the first message includes power control information for a first beam of the second device, the first beam includes at least one beam, and the power control information includes a power control command; and receiving a signal sent by the second device by using the first beam, where a transmit power of a signal on the first beam is determined based on the power control information. The power control method provided in the embodiments of this application fully considers characteristics of NR to ensure efficient and proper allocation of power and thereby improve overall performance of a system.

### CROSS-REFERENCE TO RELATED APPLICATIONS

This application is a continuation of International Application No. PCT/CN2017/118379, filed on Dec. 25, 2017, which claims priority to Chinese Patent Application No. 201710002391.4, filed on Jan. 3, 2017. The disclosures of the aforementioned applications are hereby incorporated by reference in their entireties.

### TECHNICAL FIELD

This application relates to the field of wireless communications technologies, and specifically, to a power control method and a communications device.

### BACKGROUND

As one of key techniques of the new radio access technology (NR), high frequency (HF) has been widely researched on for its ability to provide more spectrum resources, support a larger quantity of antennas, and increase system capacities. As a frequency increases, a wavelength of a radio signal becomes correspondingly shorter. A shorter wavelength greatly reduces sizes of antennas on both a receive end and a transmit end, so that a plurality of antennas can be easily integrated into a space-limited panel. A multi-antenna beamforming technology is used to concentrate transmit signal energy in one direction for transmission. This can effectively increase coverage and further improve communication performance. Correspondingly, a receiver can form a directional receive beam, to receive, with a high gain, a radio signal arriving in a given space direction. With continuous evolvement of antenna packaging technology, a plurality of antenna elements can be more easily nested and combined with a chip to form an antenna panel or an antenna array, so that a transmitter can be configured with a plurality of low-correlation antenna arrays. A plurality of antenna panels can independently form transmit beams, so that one transmitter can send data streams using different beams to increase capacity or reliability of transmission.

Power control is relatively crucial for an entire wireless communications system. However, no desirable power control method appropriate for NR is available yet at present.

### SUMMARY

A power control method and a communications device provided in embodiments of this application may be applied to NR to ensure efficient and proper allocation of power and thereby improve overall performance of a system.

According to a first aspect, an embodiment of this application provides a power control method, including: sending, by a first device, a first message to a second device, where the first message includes power control information for a first beam of the second device, the first beam includes at least one beam, and the power control information includes a power control command; and receiving, by the first device, a signal sent by the second device by using the first beam, where a transmit power of a signal on the first beam is determined based on the power control information. The power control method fully considers characteristics of NR to ensure efficient and proper allocation of power and thereby improve overall performance of a system.

In a possible implementation, the first device performs power control on a plurality of beams and/or beam sets of the second device in a time division manner. A sending occasion of the first message is associated with the first beam. In this way, signaling overheads can be effectively reduced.

In a possible implementation, the first message may include a plurality of pieces of independent power control information, and each piece of independent power control information is corresponding to one beam or beam set. Furthermore, a bit information location of the power control information for each beam or beam set in the first message can be fixed in accordance with related configuration information. In this way, signaling overheads can be effectively reduced.

In a possible implementation, the power control information may further include an identifier of the first beam. Which beam or beam set is corresponding to a power control command can be learned from the identifier.

In a possible implementation, the first beam is a beam set. When the power control information includes an identifier of a beam set, the power control information may be effective to all beams in the beam set. Therefore, for a plurality of beams, only one piece of power control information may be sent, reducing signaling overheads.

In a possible implementation, the first device sends, to the second device, information indicating a quantity of pieces of power control information carried in the first message, reducing complexity of blind detection.

In a possible implementation, the first device receives a second message from the second device, where the second message includes information indicating a capability of sharing power among beams of the second device. The second message may further include a sum of maximum transmit powers of beams among which power is shared and/or maximum transmit powers of beams among which power is not shared.

In a possible implementation, the first device sends a third message to the second device, where the third message includes information about a maximum transmit power allowed by the first device, where the information about the allowed maximum transmit power may be respective maximum transmit powers allowed for the beams among which power is not shared and/or a sum of maximum transmit powers allowed for the beams among which power is shared. The third message may further include information of beams allowed by the first device to participate in power sharing.

In a possible implementation, the first device may further receive power control information sent by another device. After receiving and processing the power control information, sent by the another device, corresponding to a beam and/or beam set, the first device sends at least one piece of power control information to the second device by using the first message. In this way, one of a plurality of first devices implements a central control function. All power control information for the second device is sent by the first device provided with the central control function. In this case, the first message sent by the base station may include power control information of the base station, and may also include power control information of another base station. Alternatively, the base station may send a plurality of first messages at different time points, and deliver power control information for a plurality of beams and/or beam sets of the terminal to the terminal, provided that the terminal can identify the power control information for different beams and/or beam sets.

According to a second aspect, an embodiment of this application further provides a power control method, including:
receiving, by a second device, a first message from a first device, where the first message includes power control information for a first beam of the second device, the first beam includes at least one beam, and the power control information includes a power control command; and sending a signal to the first device on the first beam, where a transmit power of a signal on the first beam is determined based on the power control information.

In a possible implementation, the power control information further includes an identifier of the first beam.

In a possible implementation, the power control method may further include: receiving, from the first device, information indicating a quantity of pieces of power control information carried in the first message.

In a possible implementation, the power control method may further include: sending, by the second device, a second message to the first device, where the second message includes information indicating a capability of sharing power among beams of the second device. The second message may further include a sum of maximum transmit powers of beams among which power is shared and/or maximum transmit powers of beams among which power is not shared.

In a possible implementation, to optimize transmit powers of signals on beams of the second device, the method may further include: if a sum of transmit powers of signals on beams, among which power can be shared, of the second device is greater than the sum of the maximum transmit powers allowed for the beams among which power is shared, adjusting downwards a transmit power of a signal on at least one of the beams among which power can be shared, so that the sum of the transmit powers of the signals on the beams among which power can be shared is less than or equal to the sum of the maximum transmit powers allowed for the beams among which power is shared.

The power control method provided in this embodiment of this application fully considers characteristics of NR through beam-specific power control to ensure efficient and proper allocation of power and thereby improve overall performance of a system.

According to a third aspect, an embodiment of this application further provides a communications device, where the communications device is provided with functions of the first device in all the foregoing exemplified power control methods. The functions may be implemented by hardware, or may be implemented by hardware executing corresponding software. The hardware or software includes one or more modules corresponding to the foregoing functions. For example, the communications device may include a receiver and a transmitter, and in addition, may further include a processor.

According to a fourth aspect, an embodiment of this application provides a communications device, where the communications device is provided with functions of the second device in all the foregoing exemplified power control methods. The functions may be implemented by hardware, or may be implemented by hardware executing corresponding software. The hardware or software includes one or more modules corresponding to the foregoing functions. For example, the communications device may include a receiver and a transmitter, and in addition, may further include a processor.

According to another aspect, an embodiment of this application provides a computer storage medium, configured to store a computer software instruction for use by the communications device in the third aspect, where the computer software instruction includes a program designed to execute that aspect.

According to still another aspect, an embodiment of this application provides a computer storage medium, configured to store a computer software instruction for use by the communications device in the fourth aspect, where the computer software instruction includes a program designed to execute that aspect.

### BRIEF DESCRIPTION OF DRAWINGS

FIG. 1 is a schematic diagram of a wireless communications system according to an embodiment of this application;

FIG. 2 is a schematic diagram of beam communication according to an embodiment of this application;

FIG. 3 is another schematic diagram of beam communication according to an embodiment of this application;

FIG. 4 is a schematic diagram of a power control method according to an embodiment of this application;

FIG. 5 is a schematic structural diagram of power control information according to an embodiment of this application;

FIG. 6 is a schematic diagram of a power control method according to another embodiment of this application;

FIG. 7a is a schematic diagram of timing of signals on beams according to an embodiment of this application;

FIG. 7b is a schematic diagram of another timing of signals on beams according to an embodiment of this application;

FIG. 8 is a schematic structural diagram of a communications device according to an embodiment of this application;

FIG. 9 is a schematic structural diagram of a communications device according to an embodiment of this application;

FIG. 10 is a schematic structural diagram of a communications device according to an embodiment of this application; and

FIG. 11 is a schematic structural diagram of a communications device according to an embodiment of this application.

### DESCRIPTION OF EMBODIMENTS

The following describes the embodiments of this application with reference to the accompanying drawings.

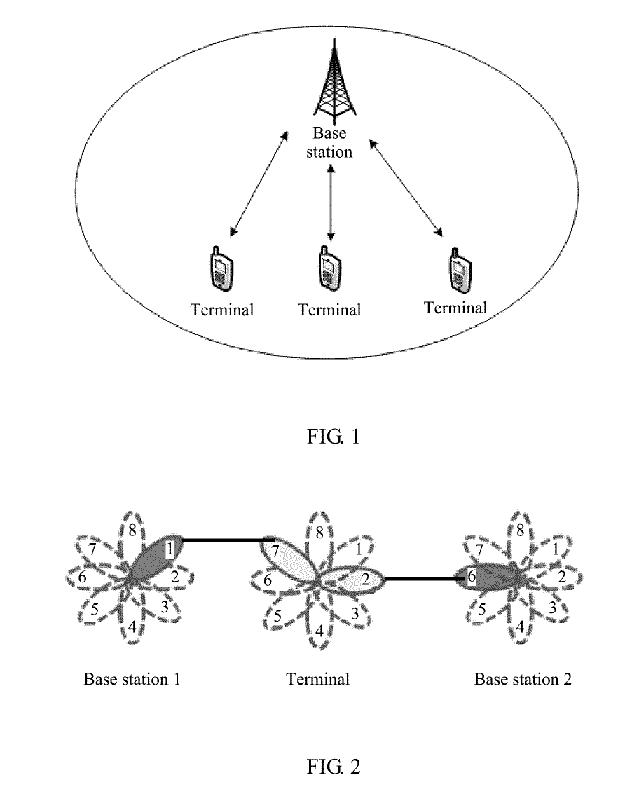

FIG. 1 is a schematic diagram of a wireless communications system to which a technical solution in the embodiments of this application is applicable.

In the solution in the embodiments, the communications system in FIG. 1 at least includes at least one base station and a plurality of terminals.

The system architecture and application scenarios described in the embodiments of this application are intended to describe the technical solution in the embodiments of this application more clearly, and do not constitute limitations on the technical solution in the embodiments of this application. Specifically, the communications system in the embodiments of this application may be, for example, 5G.

The base station mentioned in the embodiments of this application is an apparatus deployed in a radio access network and configured to provide a terminal with a wireless communication function. The base station may include various forms of macro base stations, micro base stations (also referred to as small cells), relay stations, transmission/reception points (TRPs), and the like. In systems that use different radio access technologies, a device functioning as a base station may have different names. For ease of description, all the foregoing apparatuses that are configured to provide a terminal with a wireless communication function are collectively referred to as base stations in all the embodiments of this application.

A terminal included in the embodiments of this application may include various handheld devices, in-vehicle devices, wearable devices, or computing devices that have a wireless communication function, or other processing devices connected to a wireless modem. The terminal may also be referred to as a mobile station (MS for short), user equipment, or terminal equipment, and may further include a subscriber unit, a cellular phone, a smartphone, a wireless data card, a personal digital assistant (PDA) computer, a tablet computer, a wireless modem, a handheld device (handheld), a laptop computer, a cordless phone or a wireless local loop (WLL) station, a machine type communication (MTC) terminal, and the like. For ease of description, all the devices mentioned above are collectively referred to as terminals in all the embodiments of this application.

It should be noted that a quantity and types of terminals included in the communications system shown in FIG. 1 are merely examples, and the embodiments of this application are not limited thereto.

Generally, one antenna panel forms beams in one direction at one time. In this beam direction, different physical signals or physical channels can be carried. For a same type of physical channel or physical signal, one beam may include one or more antenna ports for transmitting a data channel, a control channel, a sounding reference signal, and the like. Alternatively, one beam may further transmit a physical channel used for random access, and the physical channel may be transmitted in any antenna ports. For example, transmit beams may be distribution of signal strength in different spatial directions after signals are transmitted from antennas, and receive beams may be distribution of signal strength in different spatial directions for radio signals received by antennas. It can be understood that one or more antenna ports in one beam may also be considered as an antenna port set. Therefore, one antenna port set includes at least one antenna port. Beam and antenna port set may be used interchangeably in the embodiments of this application.

Specifically, a beam may refer to a precoding vector that has specific energy transmission directivity and that can be identified by index information. The energy transmission directivity means that a signal precoded using the precoding vector is received with more desirable power, for example, with a signal-to-noise ratio meeting needs of reception and demodulation, within a specific range of spatial locations, while in the other spatial locations, a signal precoded using the precoding vector is received with lower power, failing the signal-to-noise ratio to meet needs of reception and demodulation. Different communications devices may have different precoding vectors, that is, correspond to different beams. In accordance with configuration or capability of the communications device, one communications device may use one or more of a plurality of different precoding vectors at a time, to form one or more beams simultaneously. The beam may be understood as a spatial resource. One piece of index information may be used to identify a beam, and the index information may be correspondingly configured as a resource ID corresponding to the user, for example, an ID or a resource of a configured channel state information reference signal (CSI-RS), an ID or a resource of a configured uplink sounding reference signal (SRS), or index information explicitly or implicitly carried in a specific signal or channel carried by the beam, including but not limited to sending a synchronization signal or a broadcast channel to indicate the index information of the beam.

A power control method in this embodiment of this application may be applied to scenarios in which a first device performs power control, during communication between the first device and a second device, on a signal sent by the second device to the first device. For example, in an uplink transmission scenario, the first device may be a base station and the second device may be a terminal. In a D2D scenario, the first device may be a terminal and the second device may be another terminal. This is not limited in this embodiment of this application.

For ease of description and understanding, that the first device is a base station and the second device is a terminal is used as an example for description in the following embodiments.

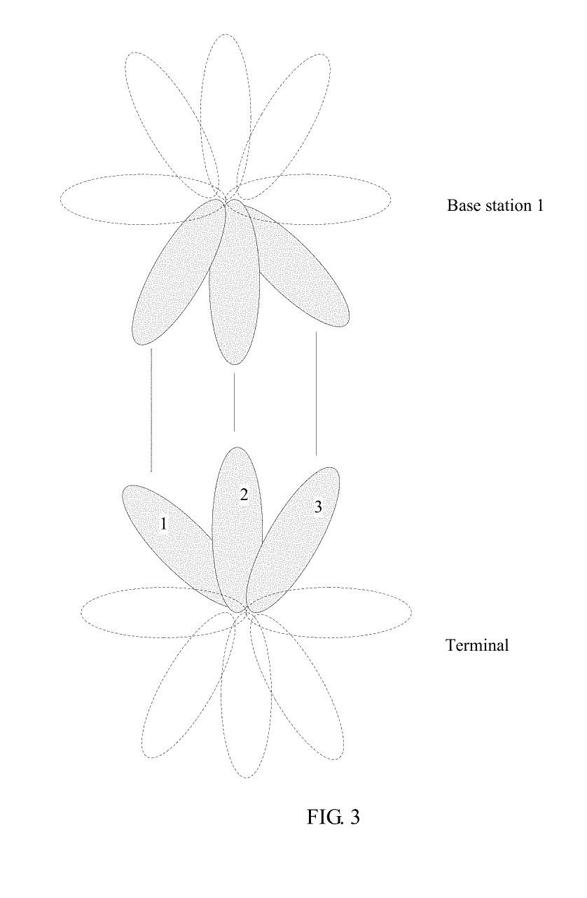

A terminal may use a plurality of beams to communicate with different base stations. As shown in FIG. 2, the terminal uses a beam 7 and a beam 2 to communicate with a base station 1 and a base station 2, respectively. Alternatively, a terminal may use a plurality of beams to communicate with one base station. As shown in FIG. 3, the terminal use three beams to communicate with a base station 1. Certainly, in addition to conditions similar to FIG. 2 or FIG. 3, other scenarios may also be appropriate, which are not illustrated one by one in the embodiments of this application.

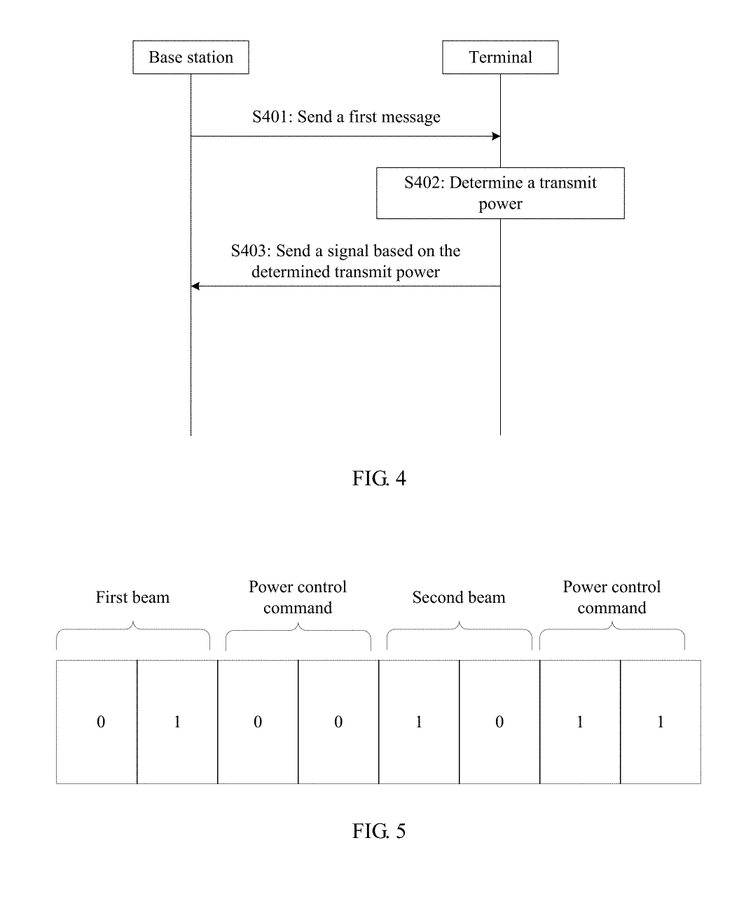

A power control method is provided in an embodiment of this application. As shown in FIG. 4, the method includes the following steps.

S401: A base station sends a first message to a terminal.

The first message may include power control information for a first beam of the terminal, and the first beam may include at least one beam. As described above, the terminal may use one or more beams to communicate with at least one base station. In the scenario shown in FIG. 3, for example, the three beams communicating with the base station 1 may be regarded as an entirety to be the first beam, in which case, the first beam may be understood as a beam set, or the three beams may be regarded as independent beams. Alternatively, in the scenario shown in FIG. 2, the beam 7 and the beam 2 are independent beams.

It can be understood that the first message may also include other information in addition to the power control information. This is not limited in this embodiment of this application. The power control information may also include a power control command, and in addition, on a basis of the power control command, other information related to power control may also be included.

The first message may be transmitted through a downlink control channel, and the downlink control channel, for example, may be a channel similar to a physical downlink control channel (PDCCH) in Long Term Evolution (LTE).

The power control command may be a relative command, or may be an absolute command. The relative command may be so understood that after the terminal receives the power control command, a transmit power adjustment result of the terminal is similar to relative adjustment on a basis of a current transmit power. The relative command may also be referred to as an accumulative command. The absolute command may be so understood that after the terminal receives the power control command, a transmit power adjustment result of the terminal is similar to adjustment on a basis of an initial transmit power. Specifically, what power control command is used may be related to factors such as a network requirement and a specific transmission format. This is not limited in this embodiment of this application. For example, a higher layer message may be used to configure the power control command.

Table 1 shows an example of possible values of power control commands. It should be noted that in this embodiment of this application, specific power control commands corresponding to the values of the power control command field are not limited, and a specific quantity of bits of the power control command field is not limited either. A bit length of the power control command field may be predefined, or may be variable.

TABLE 1

| Value of power | Relative power | Absolute power |
|---|---|---|
| control | control | control |
| command field | command (dB) | command (dB) |
| 0 | −1 | −4 |
| 1 | 0 | −1 |
| 2 | 1 | 1 |
| 3 | 3 | 4 |

Optionally, the power control information transmitted by the first message may be implemented in any one of the following manners.

(1) The base station performs power control on a plurality of beams and/or beam sets of the terminal in a time division manner. To be specific, occasions for sending power control information for different beams/beam sets are different, and a sending occasion of the first message is associated with the first beam. For example, it is assumed that the base station 1 is to send respective power control information for the beam 1 and the beam 2 of the terminal. In this case, the base station 1 may send the power control information for the beam 1 at a first occasion, and send the power control information for the beam 2 at a second occasion. An occasion for sending a specific beam may be determined based on related configuration information, and the configuration information is related to indexes of beams/beam sets communicating with at least one base station. For example, at least one of processes of beam training, beam alignment, channel-state information measurement, and sounding reference signal sending can be used to determine that at least one beam and/or beam set of the base station and at least of beam and/or beam set of the terminal are used for signal transmission. The base station may indicate, to the terminal by using configuration information, an index of the determined at least one beam or beam set for use in uplink signal transmission. When a beam set is determined, in addition to an index of the beam set, information of specific beams included in the beam set may also be sent to the terminal, so when receiving the identifier of the beam set, the terminal can correlate the beam set with those specific beams.

(2) The first message may include a plurality of pieces of independent power control information, and each piece of independent power control information is corresponding to one beam or beam set. A bit information location of the power control information for each beam or beam set in the first message can be fixed in accordance with related configuration information. For example, the first message may further include power control information for a second beam, and locations of the power control information for the first beam and the power control information for the second beam in the first message are determined based on configuration information, where the second beam includes at least one beam. The configuration information is related to indexes of beams or beam sets communicating with at least one base station. This configuration information is similar to the configuration information described in the foregoing manner (1). Details are not described herein again.

(3) The power control information may further include an identifier of the first beam, and which beam or beam set is corresponding to the power control command may be learned from the identifier. A combination of the identifier and the power control command may be referred to as the power control information. One identifier may be allocated to each beam or beam set for which independent power control is performed.

The identifier of the first beam may be shown in Table 2, and different values correspondingly represent different beams or beam sets. It can be understood that Table 2 is merely an example for description. In this embodiment of this application, a specific manner of correspondence is not limited, and a quantity of bits representing the identifier of the first beam is not limited either. For example, it is assumed that the quantity of bits for power control in the first message may be eight, for providing power control information for two independent beams or beam sets, and the two independent beams or beam sets are referred to as the first beam and the second beam, respectively. The power control information for the first beam and the power control information for the second beam may each occupy four bits. At least one of the four bits is used to identify the beam or beam set, and the other bits serve as a power control field. For example, as shown in FIG. 5, the first four bits are the power control information for the first beam, and the last four bits are the power control information for the second beam.

TABLE 2

| Value of identifier | Beam |
|---|---|
| 0 | 0 |
| 1 | 1 |
| 2 | 2 |
| 3 | 3 |

It can be understood that in the foregoing manners, when the power control information includes an identifier of a beam set, the power control information may be effective to all beams in the beam set. Therefore, for a plurality of beams, only one piece of power control information may be sent, reducing signaling overheads.

Information of a beam included in the beam set, also a correspondence of the beam set and the beam, can be sent to the terminal by using a specific message, for example, the foregoing described configuration information or a following described third message. This is not limited in this embodiment of this application.

It should be noted that the foregoing manners of transferring power control information by using a first message are applicable to scenarios in which a terminal uses beams or beam sets to communicate with one or more base stations. If the base stations send independent power control information to terminals that communicate with the base stations, the base stations may perform processing in similar ways.

S402: The terminal receives the first message sent by the base station, and determines a transmit power of a signal on the first beam based on power control information in the first message.

After receiving the first message, the terminal may demodulate the first message and obtain the power control information corresponding to the first beam, to determine the transmit power of a signal on the first beam.

Optionally, the terminal may determine the transmit power of a signal on the first beam in a plurality of specific manners. For example:
the transmit power of a signal on the beam is determined based on a current base open-loop working point and a power control command corresponding to the beam, for example:
Transmit power=base open-loop working point+f(ΔTPC)+other power.

f(ΔTPC) represents an accumulated quantity in a case of an accumulative power control command. In a case of an absolute power control command, f(ΔTPC) represents a power adjustment value in a current power control command. The other power may be determined by a plurality of factors, and is related to a specific uplink signal and/or channel. For example, at least one of the following related factors may be included: a bandwidth of a to-be-sent uplink signal and/or channel, a modulation and coding order of the uplink signal and/or channel, a format of the uplink signal and/or channel, a semi-statically configured power, a power adjustment value indicated in a random access response message, channel state information feedback, and a hybrid automatic repeat request acknowledgment message. The uplink channel includes but is not limited to one or more of an SRS, a physical uplink control channel (PUCCH), and a physical uplink shared channel (PUSCH).

Further, the base station may configure a base open-loop working point for an uplink beam of the terminal based on cell load and neighboring cell interference. The base open-loop working point may be described as follows:
Base open-loop working point=P0+β*PL.

P0 is a semi-static reference power that is determined by a sum of a common power level (measured by dBm) P_{O_NOMINAL} of all terminals served by the base station and an offset value P_{O_UE} specific to a transmit beam of the terminal. P_{O_NOMINAL} and P_{O_UE} are configured through a system broadcast message and higher layer signaling, respectively. β is a fractional path loss compensation factor used to control interference from an uplink beam of an edge terminal to a neighboring cell and may be configured by using a higher layer message. PL is a path loss compensation value for a path from the terminal to the base station, used to compensate for a path loss from the terminal to the base station. Path loss information may be obtained based on a reference signal received power reported by the terminal and a reference signal transmit power on the base station side.

It should be understood that the foregoing described calculation formulas for the base open-loop working point and the transmit power are merely examples. The formulas have various variations, or parameters in the formulas may be replaced by other related parameters, for which no more examples are provided in this embodiment of this application.

S403: The terminal sends a signal to the base station on the first beam based on the transmit power of a signal on the first beam.

Correspondingly, the base station may receive the signal that is sent by the terminal on the first beam.

The power control method provided in this embodiment of this application fully considers characteristics of NR to ensure efficient and proper allocation of power and thereby improve overall performance of a system.

As described above, the first message may include more than one piece of power control information. Optionally, to improve efficiency of demodulation, on a basis of the foregoing embodiment, an embodiment of this application may further include: sending, by the base station, indication information of a quantity of pieces of power control information included in the first message to the terminal.

The indication information of the quantity of pieces of power control information may be included in the first message, or may be sent in other manners. This is not limited in this embodiment of this application. For example, the base station may notify the indication information of the quantity of pieces of power control information to the terminal by using higher layer signaling or physical layer signaling.

By indicating the quantity of pieces of the power control information, complexity of blind detection by the terminal for channels carrying power control information can be reduced. For example, if it is indicated that the first message includes two pieces of power control information, once the terminal detects two pieces of power control information, detection for related channels can be terminated, thereby reducing the complexity of blind detection.

Optionally, when the terminal uses different beams and/or beam sets to communicate with a plurality of base stations, each of the plurality of base stations may send power control information for a beam and/or beam set communicating with the base station to the terminal, or one of the plurality of base stations, for example, one similar to a base station that implements a central control function, may send power control information for the beams and/or beam sets to the terminal. If one of the plurality of base stations sends the power control information for the beams and/or beam sets to the terminal, on a basis of the foregoing method embodiment, the method in the embodiments of this application may further include: receiving, by the base station, power control information sent by another base station.

After receiving and processing the power control information, sent by the another base station, corresponding to a beam and/or beam set, the base station sends at least one piece of power control information to the terminal by using the first message. In this case, the first message sent by the base station may include power control information of the base station, and may also include power control information of another base station. Alternatively, the base station may send a plurality of first messages at different time points, and deliver power control information for a plurality of beams and/or beam sets of the terminal to the terminal, provided that the terminal can identify the power control information for different beams and/or beam sets. This is not limited in this embodiment of this application.

For example, in the scenario shown in FIG. 2, the terminal uses the beam 7 and the beam 2 to communicate with the base station 1 and the base station 2, respectively. It is assumed that all power control information is sent to the terminal by the base station 1. Then, the base station 2 sends power control information corresponding to the beam 2 to the base station 1, and the base station 1 sends the power control information for the beam 7 and the power control information for the beam 2 to the terminal by using at least one first message.

Optionally, in this embodiment of this application, the base station may determine specific power control information for the first beam in the following manners.

The base station determines a specific value of the power control command based on at least one of these factors: an uplink sounding reference signal, an uplink demodulation reference signal, an uplink block error rate, and a modulation and coding order of the terminal. It can be understood that for different network requirements or conditions, the base station may determine the specific power control information in different manners. This is not limited in this embodiment of this application.

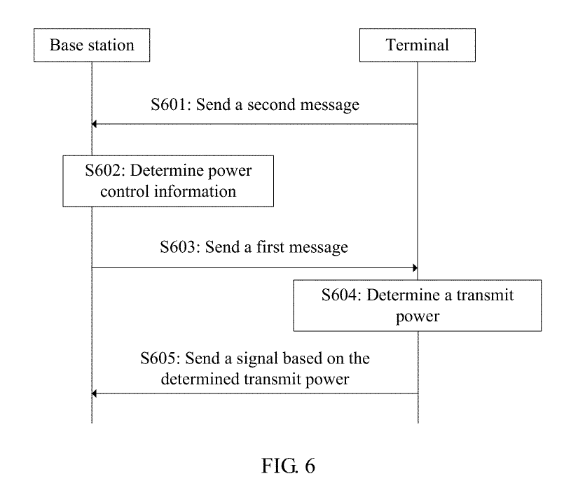

Optionally, the terminal may further send capability information of the terminal to the base station, for the base station to determine the specific power control information. As shown in FIG. 6, another embodiment of this application further provides a power control method, including the following steps.

S601: A terminal sends a second message to a base station, where the second message includes information indicating a capability of sharing power among beams of the terminal.

The capability of sharing power among beams may include any one of the following:

(1) Power can be shared among all beams of the terminal; (2) Power can be shared among some beams of the terminal; and (3) Power can be shared among no beams.

The information indicating the capability of sharing power among beams may be notified in a plurality of manners. This is not limited in this embodiment of this application. It is assumed that the terminal has a total of eight beams (beams 1 to 8). An 8-bit piece of information can be used to indicate the capability of sharing power among beams. For example, “10001100” may indicate that power can be shared among the beam 1, the beam 5, and the beam 6. Alternatively, two 4-bit pieces of information may be used to indicate the capability of sharing power among beams. For example, “1001” and “0110” indicate that power can be shared between beam 1 and the beam 4 and between the beam 6 and the beam 7. Alternatively, if power can be shared among all beams, one bit, for example, “1”, may be used to indicate the capability of sharing power, and if power can be shared among no beams, also one bit, for example, “0”, may be used to indicate the capability of sharing power.

In addition, the terminal may send a related maximum transmit power (a power capacity) to the base station alongside with the information indicating the capability of sharing power among beams. When power can be shared among no beams, a maximum transmit power for each beam may be sent to the base station. When power can be shared among all beams, a sum of maximum transmit powers of all the beams may be sent to the base station. When power can be shared among some beams, a sum of maximum transmit powers of the beams among which power is shared may be sent to the base station.

It can be understood that the information indicating the capability of sharing power among beams and the related maximum transmit power may be included in one message, that is, the second message, to be sent to the base station, or may be sent to the base station by using different messages. A type and a structure of the second message are not limited in this embodiment of this application.

S602: The base station receives the second message and determines power control information for a first beam based on the second message.

After receiving the second message, the base station can learn specific beams among which power can be shared and among which power cannot be shared, and can further learn the related maximum transmit power, and determine a corresponding allowed maximum power. For example, based on at least one of the following factors: a current condition of interference in a network, a signal quality requirement and an out-of-band emission requirement for an uplink signal of the terminal, a spectrum emission mask and a spurious emission requirement for an uplink signal, impact of an uplink signal on a human body, and the like, the base station may determine the corresponding maximum power allowed by the base station and/or beams among which the maximum power can be shared. A result determined by the base station is sent to the terminal, for example, by using a third message. Optionally, the third message may include beams among which power can be shared and a sum of corresponding maximum powers allowed for the beams among which power is shared, and may further include respective maximum powers allowed for beams among which power is not shared. The third message may include different content depending on different determining results. It can be understood that information, determined by the base station, about the corresponding allowed maximum power and/or the beams among which this maximum power can be shared may be sent by using a third message that is different from a first message, or may be carried in a first message to be sent together with power control information. This is not limited in this embodiment of this application. Sending by using a third message may be performed either before S603 or after S603. This is not limited in this embodiment of this application.

On a basis of the foregoing manner of determining specific power control information for a first beam, power control is performed on the terminal based on also the second message. This makes more proper allocation of power among beams, and ensures with best effort that ideal transmit powers can be allocated to signals on different beams, thereby improving transmission performance.

S603: The base station sends a first message to the terminal.

S604: The terminal receives the first message sent by the base station, and determines a transmit power of a signal on the first beam based on power control information in the first message.

S605: The terminal sends a signal to the base station on the first beam based on the transmit power of a signal on the first beam.

S603 to S605 in this embodiment of this application are similar to S401 to S403 shown in the embodiment in FIG. 4, respectively. The embodiment shown in FIG. 6 may further include other steps or solutions described in the foregoing embodiment, for example, the base station sends the information indicating the quantity of pieces of power control information included in the first message to the terminal. Therefore, S601 to S602 may be applied to any embodiment of this application.

Further, on a basis of the embodiment shown in FIG. 4 or FIG. 6, to optimize transmit powers of signals on beams of a terminal, this embodiment of this application may further include: if a sum of transmit powers of signals on beams, among which power can be shared, of the terminal is greater than the sum of the maximum transmit powers allowed for the beams among which power is shared, adjusting downwards a transmit power of a signal on at least one of the beams among which power can be shared, so that the sum of the transmit powers of the signals on the beams among which power can be shared is less than or equal to the sum of the maximum transmit powers allowed for the beams among which power is shared.

For example, it is assumed that power can be shared between a beam 1 and a beam 2 that are for communication with a base station, and that a sum of the maximum transmit powers allowed for the beam 1 and the beam 2 is Pₘₐₓ. The transmit power of the signal on at least one of the beams among which power can be shared may be adjusted downwards in the following manners.

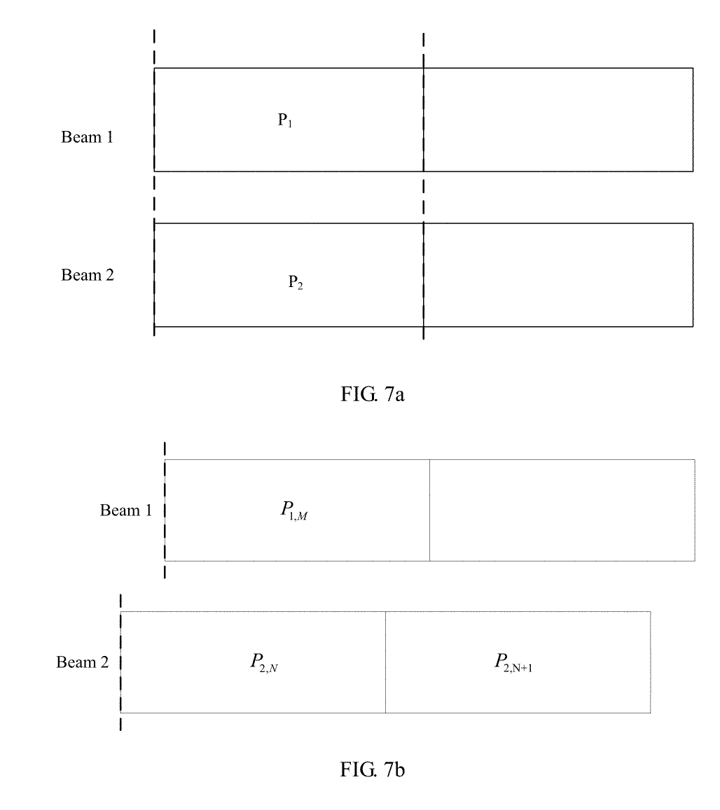

(1) A signal on the beam 1 and a signal on the beam 2 exactly coincide in a power control time unit. As shown in FIG. 7a, the transmit powers, obtained based on the power control information, of the signal on the beam 1 and the signal on the beam 2 are P₁ and P₂ respectively. If P₁+P₂>Pₘₐₓ, the terminal may adjust downwards a power of at least one of the beam 1 and the beam 2, so that the sum of the power for the beam 1 and the power for the beam 2 is less than or equal to Pₘₐₓ after the adjustment. For example, P₁ and P₂ are multiplied by their respective scaling factors: P₁′=P₁*alpha1 and P₂′=P₂*alpha2. P₁′+P₂′ is less than or equal to Pₘₐₓ. 0<alpha1≤1, 0<alpha2≤1, and alpha1 and alpha2 are related to channels or signals carried on the beam 1 and the beam 2, respectively. Corresponding values may be configured by the base station, or may be determined by the terminal. This is not limited in this embodiment of this application. (2) A signal on the beam 1 and a signal on the beam 2 do not exactly coincide in a power control time unit. It is assumed that an M^{th} power control time unit of the beam 1 overlaps an N^{th} power control time unit of the beam 2 in time domain, and timing of the N^{th} power control time unit of the beam 2 precedes timing of the M^{th} power control time unit of the beam 1. As shown in FIG. 7b, at least one of a transmit power of the signal, in the M^{th} power control time unit, on the beam 1 and a first transmit power of the signal on the beam 2 may be adjusted downwards. The first transmit power is the greater value between a transmit power of a signal in the N^{th} power control time unit and a transmit power of a signal in the (N+1)^{th} power control time unit. For example, a specific adjustment manner may be: α₁·P_{1,M}+α₂·max{P_{2,N}, P_{2,N+1}}≤Pₘₐₓ, where M and N are natural numbers, 0<α₁≤1, 0<α₂≤1, P_{1,M} represents the transmit power of the signal, in the M^{th} power control time unit, on the beam 1, P_{2,N} represents the transmit power of the signal, in the N^{th} power control time unit, on the beam 2, and P_{2,N+1} represents the transmit power of the signal, in the (N+1)^{th} power control time unit, on the beam 2. α₁ and α₂ are related to channels or signals carried on the beam 1 and the beam 2, and their corresponding values may be configured by the base station, or may be determined by the terminal. This is not limited in this embodiment of this application. Further, a power control time unit is a time granularity of power control, and the power control time unit may be a minimum scheduling time unit, or may be an agreed time unit.

It should be noted that the foregoing embodiments of this application are described by using an example in which the first device is the base station and the second device is the terminal. For another scenario, for example, a D2D scenario, a method may be similar. Only execution bodies of steps change. No more details are described herein.

In the foregoing embodiments provided in this application, the power control method provided in the embodiments of this application is described from perspectives of network elements and interaction between network elements. It can be understood that, to implement the foregoing functions, network elements such as the terminal and the base station include corresponding hardware structures and/or software modules for performing the functions. A person of ordinary skill in the art should easily be aware that the units and algorithms steps in the examples described with reference to the embodiments disclosed in this specification may be implemented by hardware or a combination of hardware and computer software. Whether a certain function is performed by hardware or hardware driven by computer software depends on particular applications and design constraints of the technical solutions. A person skilled in the art can implement the described functions by using a different method for each specific application.

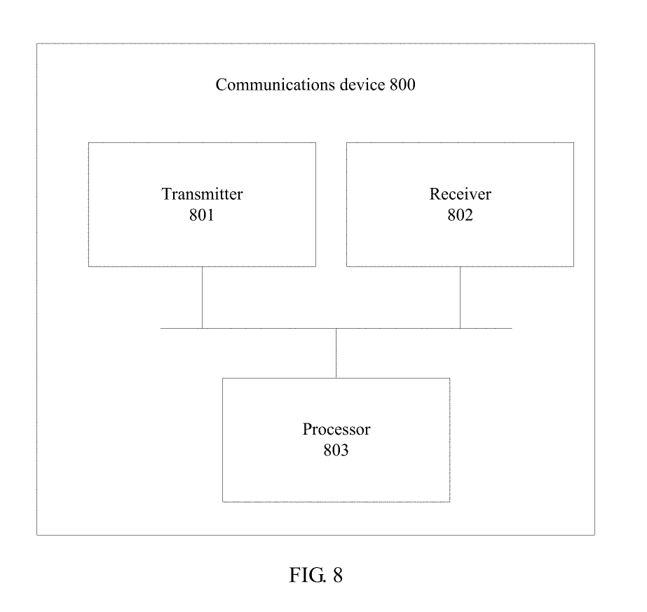

An embodiment of this application further provides a communications device 800. The communications device 800 is configured to implement functions of the first device in the foregoing method embodiments. As shown in FIG. 8, the communications device 800 may include:
a transmitter 801, configured to send a first message to a second device, where the first message includes power control information for a first beam of the second device, the first beam includes at least one beam, and the power control information includes a power control command; and
a receiver 802, configured to receive a signal sent by the second device by using the first beam, where a transmit power of a signal on the first beam is determined based on the power control information.

Optionally, the transmitter 801 may be further configured to send, to the second device, information indicating a quantity of pieces of power control information carried in the first message.

Optionally, the receiver 802 may be further configured to receive a second message from the second device, where the second message includes information indicating a capability of sharing power among beams of the second device.

Optionally, the transmitter 801 may be further configured to send configuration information, where the configuration information is related to indexes of beams/beam sets communicating with at least one communications device 800.

Optionally, the communications device 800 may further include a processor 803, and the processor 803 is configured to determine, based on the configuration information, a sending occasion of the power control information in the first message or a location of power control information in the first message.

The processor 803 may be configured to determine the power control information for the first beam. How the processor 803 specifically determines the power control information is not limited in this embodiment of this application.

Optionally, the processor 803 may be further configured to determine, based on a second message received by a receiver 802, a corresponding allowed maximum power and/or beams among which this maximum power can be shared. Then, the transmitter 801 may be further configured to send a third message to the second device, where the third message includes information about a maximum transmit power allowed by the first device, where the information about the allowed maximum transmit power may be respective maximum transmit powers allowed for beams among which power is not shared and/or a sum of maximum transmit powers allowed for the beams among which power is shared. Optionally, the third message may further include information of beams allowed by the first device to participate in power sharing. Alternatively, optionally, the first message may further include the information about the maximum transmit power allowed by the first device, and may also include information of beams allowed by the first device to participate in power sharing.

Optionally, the receiver 802 may be further configured to receive power control information sent by another communications device, and the transmitter 801 is configured to send the received power control information sent by the another communications device to the second device.

It can be understood that the transmitter 801 and the receiver 802 may stand separately, or may be integrated into a transceiver. This is not limited in this embodiment of this application.

The communications device 800 in this embodiment of this application may further include a memory. The memory may be configured to store program code and data of the communications device 800. It can be understood that FIG. 8 shows only a simplified design of the communications device 800. In actual application, the communications device 800 may include any quantities of transmitters, receivers, processors, memories, and the like. All communications devices that can implement the embodiments of this application fall within the protection scope of this application.

It should be understood that the foregoing and other operations and/or functions of the units in the communications device in the embodiment of this application shown in FIG. 8 are intended to implement the corresponding procedures in any communication method in FIG. 4 to FIG. 7b. For brevity, details are not repeated herein.

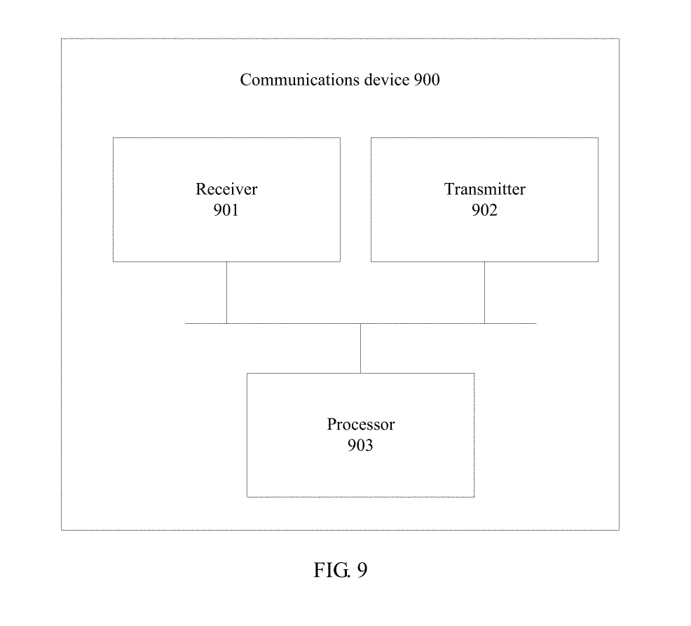

An embodiment of this application further provides a communications device, configured to implement functions of the second device in the foregoing method embodiments. As shown in FIG. 9, the communications device 900 may include:
a receiver 901, configured to receive a first message from a first device, where the first message includes power control information for a first beam of the communications device 900, the first beam includes at least one beam, and the power control information includes a power control command; and
a transmitter 902, configured to send a signal to the first device on the first beam, where a transmit power of a signal on the first beam is determined based on the power control information.

Optionally, the receiver 901 may be further configured to receive information indicating a quantity of pieces of power control information carried in the first message from the first device.

Optionally, the communications device 900 may further include a processor 903, configured to obtain the power control information corresponding to the first beam based on the first message, to determine the transmit power of a signal on the first beam.

Optionally, the transmitter 902 may be further configured to send a second message to the first device, where the second message includes information indicating a capability of sharing power among beams of the second device. The second message may further include a sum of maximum transmit powers of beams among which power is shared and/or maximum transmit powers of beams among which power is not shared.

Optionally, the receiver 901 may be further configured to receive a third message from the first device, where the third message includes information about a maximum transmit power allowed by the first device, where the information about the allowed maximum transmit power includes respective maximum transmit powers allowed for the beams among which power is not shared and/or a sum of maximum transmit powers allowed for the beams among which power is shared. The third message may further include information of beams allowed by the first device to participate in power sharing. The processor 903 may further determine the transmit power based on also the third message. Alternatively, optionally, the first message may further include the information about the maximum transmit power allowed by the first device, and may also include information of beams allowed by the first device to participate in power sharing.

Optionally, the processor 903 may be further configured to: if a sum of transmit powers of signals on beams, among which power can be shared, of the second device is greater than the sum of the maximum transmit powers allowed for the beams among which power is shared, adjust downwards a transmit power of a signal on at least one of the beams among which power can be shared, so that the sum of the transmit powers of the signals on the beams among which power can be shared is less than or equal to the sum of the maximum transmit powers allowed for the beams among which power is shared.

The communications device 900 in this embodiment of this application may further include a memory. The memory is configured to store program code and data of the communications device 900. It can be understood that FIG. 9 shows only a simplified design of the communications device 900. In actual application, the communications device 900 may include any quantities of transmitters, receivers, processors, memories, and the like. All communications devices that can implement the embodiments of this application fall within the protection scope of this application.

It should be understood that the foregoing and other operations and/or functions of the units in the communications device in the embodiment of this application shown in FIG. 9 are intended to implement the corresponding procedures in any power control method in FIG. 4 to FIG. 7b. For brevity, details are not repeated herein.

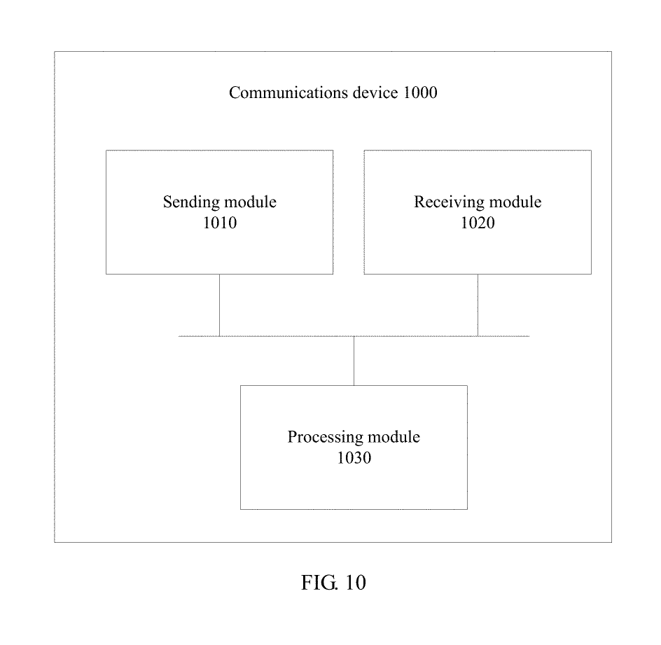

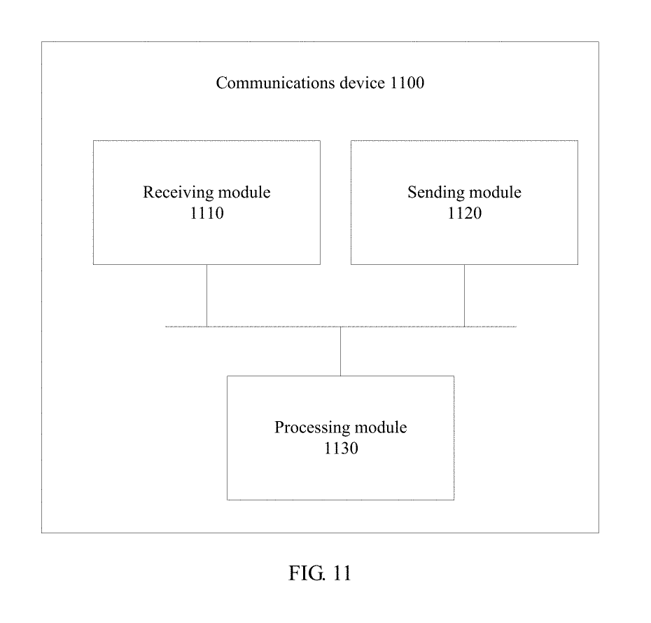

Another example structure of the communications device in the embodiments of this application is shown in FIG. 10. It should be understood that the communications device 1000 shown in FIG. 10 is merely an example. The communications device in the embodiments of this application may further include other modules or units, or include modules with functions similar to those of modules in FIG. 10.

A sending module 1010 may be configured to implement functions of the transmitter 801 in FIG. 8. A receiving module 1020 may be configured to implement functions of the receiver 802 in FIG. 8. A processing module 1030 may be configured to implement functions of the processor 803 in FIG. 8.

Another example structure of the communications device in the embodiments of this application is shown in FIG. 11. It should be understood that the communications device 1100 shown in FIG. 11 is merely an example. The communications device in the embodiments of this application may further include other modules or units, or include modules with functions similar to those of modules in FIG. 11.

A receiving module 1110 is configured to implement functions of the receiver 901 in FIG. 9. A sending module 1120 is configured to implement functions of the transmitter 902 in FIG. 9. A processing module 1130 is configured to implement functions of the processor 903 in FIG. 9.

Furthermore, the processor in the embodiments may be a central processing unit (CPU), a general-purpose processor, a digital signal processor (DSP), an application-specific integrated circuit (ASIC), a field programmable gate array (FPGA) or another programmable logic device, a transistor logic device, a hardware device, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a DSP and a microprocessor.

Method or algorithm steps described with reference to the content disclosed in this application may be implemented by hardware, or may be implemented by a processor executing a software instruction. The software instruction may be generated by a corresponding software module. The software module may be stored in a RAM memory, a flash memory, a ROM memory, an EPROM memory, an EEPROM memory, a register, a hard disk, a removable hard disk, a CD-ROM, or a storage medium of any other form known in the art. For example, a storage medium being an example is coupled to a processor, so that the processor can read information from the storage medium or write information into the storage medium. Certainly, the storage medium may alternatively be a component of the processor. The processor and the storage medium may be located in an ASIC. In addition, the ASIC may be located in a terminal. Certainly, the processor and the storage medium may alternatively exist in the terminal as separate components.

A person skilled in the art should be aware that in the foregoing one or more examples, functions described in this application may be implemented by hardware, software, firmware, or any combination thereof. When this application is implemented by software, the foregoing functions may be stored in a computer readable medium or transmitted as one or more instructions or code in the computer readable medium. The computer readable medium includes a computer storage medium and a communications medium, where the communications medium includes any medium that enables a computer program to be transmitted from one place to another. The storage medium may be any available medium accessible by a general-purpose or dedicated computer.

The objectives, technical solutions, and benefits of this application are further described in detail in the foregoing specific embodiments. It should be understood that the foregoing descriptions are merely specific implementations of this application, and are not intended to limit the protection scope of this application. Any modification, equivalent replacement or improvement made within the spirit and principle of this application shall fall within the protection scope of this application.

1. A power control method, comprising:
sending, by a first device, a first message to a second device, wherein the first message comprises power control information for a first beam of the second device, the first beam comprises at least one beam, and the power control information comprises a power control command; and
receiving, by the first device, a signal sent by the second device using the first beam, wherein a transmit power of the signal is determined based on the power control information.

2. The method according to claim 1, wherein a sending occasion of the first message is associated with the first beam.

3. The method according to claim 1, wherein the first message further comprises power control information for a second beam, and locations of the power control information for the first beam and the power control information for the second beam in the first message are determined based on configuration information, the second beam comprises at least one beam, and the configuration information is related to indexes of beams communicating with the first device.

4. The method according to claim 1, wherein the power control information further comprises an identifier of the first beam.

5. The method according to claim 1, wherein the method further comprises:
sending, by the first device to the second device, information indicating a quantity of pieces of power control information carried in the first message.

6. The method according to claim 1, further comprising:
receiving, by the first device, a second message from the second device, wherein the second message comprises information indicating a capability of sharing power among beams of the second device.

7. The method according to claim 6, wherein the second message further comprises a sum of maximum transmit powers of beams among which power is shared and/or maximum transmit powers of beams among which power is not shared.

8. The method according to claim 7, wherein the method further comprises: sending, by the first device, a third message to the second device, wherein the third message comprises information about a maximum transmit power allowed by the first device, wherein the information about the allowed maximum transmit power comprises respective maximum transmit powers allowed for the beams among which power is not shared and/or a sum of maximum transmit powers allowed for the beams among which power is shared.

9. The method according to claim 8, wherein the third message further comprises information of beams allowed by the first device to participate in power sharing.

10. A power control method, comprising:
receiving, by a second device, a first message from a first device, wherein the first message comprises power control information for a first beam of the second device, the first beam comprises at least one beam, and the power control information comprises a power control command; and
sending, by the second device on the first beam, a signal to the first device, wherein a transmit power of the signal on the first beam is determined based on the power control information.

11. The method according to claim 10, wherein the power control information further comprises an identifier of the first beam.

12. The method according to claim 10, further comprising:
receiving, by the second device from the first device, information indicating a quantity of pieces of power control information carried in the first message.

13. The method according to claim 10, further comprising:
sending, by the second device, a second message to the first device, wherein the second message comprises information indicating a capability of sharing power among beams of the second device.

14. The method according to claim 13, wherein the second message further comprises a sum of maximum transmit powers of beams among which power is shared and/or maximum transmit powers of beams among which power is not shared.

15. The method according to claim 13, further comprising: receiving, by the second device, a third message from the first device, wherein the third message comprises information about a maximum transmit power allowed by the first device, wherein the information about the allowed maximum transmit power comprises respective maximum transmit powers allowed for the beams among which power is not shared and/or a sum of maximum transmit powers allowed for the beams among which power is shared.

16. The method according to claim 15, wherein the third message further comprises information of beams allowed by the first device to participate in power sharing.

17. A communications device, comprising:
a transmitter, configured to send a first message to a second device, wherein the first message comprises power control information for a first beam of the second device, the first beam comprises at least one beam, and the power control information comprises a power control command; and
a receiver, configured to receive a signal sent by the second device using the first beam, wherein a transmit power of the signal is determined based on the power control information.

18. The device according to claim 17, wherein a sending occasion of the first message is associated with the first beam.

19. The device according to claim 17, wherein the first message further comprises power control information for a second beam, and locations of the power control information for the first beam and the power control information for the second beam in the first message are determined based on configuration information, the second beam comprises at least one beam, and the configuration information is related to indexes of beams communicating with the first device.

20. The device according to claim 17, wherein the power control information further comprises an identifier of the first beam.
